(19) United States
(12) Patent Application Publication
(10) Pub. No.: US 2018/0334928 A1
(43) Pub. Date: Nov. 22, 2018

(54) TIMING CHAIN DEVICE OF ENGINE

(71) Applicant: MAZDA MOTOR CORPORATION, Hiroshima (JP)

(72) Inventors: Michihiro YAMAUCHI, Hatsukaichi-city (JP); Tomonobu MIZUBA, Hiroshima-city (JP)

(73) Assignee: MAZDA MOTOR CORPORATION, Hiroshima (JP)

(21) Appl. No.: 15/958,269

(22) Filed: Apr. 20, 2018

(30) Foreign Application Priority Data
May 16, 2017 (JP) 2017-097475

(51) Int. Cl. F01L 1/02; F16H 7/18; F16H 7/08

(52) U.S. Cl. CPC F01L 1/022; F16H 7/06; F16H 7/08; F16H 7/18

(57) ABSTRACT

In a chain device of an engine which comprises a driving sprocket at a cylinder block, a driven sprocket at a cylinder head, and a timing chain, there are provided a chain guide which supports the timing chain and a support member which supports the chain guide, the chain guide comprises a fastening portion which is fixedly fastened to the cylinder head and a slide support portion which extends toward a side of the cylinder block beyond a boundary between the cylinder block and the cylinder head, and the support member is configured to slidably contact a front-surface lower portion of the slide support portion.

### BACKGROUND OF THE INVENTION

The present invention relates to a timing chain device of an engine which is provided to extend between a cylinder block and a cylinder head, for example.

An internal-combustion engine which is operated by fuel, such as gasoline or light oil, transfers a reciprocating motion of pistons provided inside the cylinder block to a rotational motion of a crankshaft, thereby outputting a drive force. The drive force outputted by the crankshaft is transmitted not only to a transmission which is connected to the internal-combustion engine but to camshafts for opening/closing intake/exhaust valves provided inside the cylinder head, for example.

The drive force of the crankshaft is transmitted to the camshafts via a timing chain which is stretched between a crank sprocket provided at the crankshaft and cam sprockets provided at the camshafts.

Herein, the timing chain device in which the drive force of the crankshaft is transmitted to the camshafts via the timing chain comprises a tensioner to apply a tensional force to the timing chain and a chain guide to support a slide of the timing chain in order to efficiently transmit the drive force of the crankshaft to the camshafts (see Japanese Patent Laid-Open Publication No. 2001-349396).

In the device disclosed in the above-described patent document, a lower end of the chain guide is fixedly fastened to the cylinder block and an upper end of the chain guide is fixedly fastened to the cylinder head. Accordingly, in a case of maintenance which requires removal of the cylinder head, for example, in a case where a gasket provided between the cylinder block and the cylinder head is exchanged, it is necessary to release fastening of the chain guide.

Moreover, in a case where the cylinder block and the transmission are connected such that the timing chain device is interposed between them, removing of the transmission and releasing of the fastening of the chain guide are both necessary for the maintenance which requires the removal of the cylinder head, so that the workability deteriorates further.

Therefore, the timing chain device in which the chain guide is fastened to the cylinder block and the cylinder head, which is disclosed in the above-described patent document, has a problem that the workability of the maintenance which requires the removal of the cylinder head is inferior.

### SUMMARY OF THE INVENTION

In view of the above-described problem, an object of the present invention is to provide a timing chain device of an engine which can improve the workability of the maintenance which requires the removal of the cylinder head even in a state where the engine is installed to a vehicle.

The present invention is a timing chain device of an engine, comprising a driving sprocket rotatably supported at a cylinder block of the engine, a driven sprocket rotatably supported at a cylinder head installed to the cylinder block, a timing chain stretched between the driving sprocket and the driven sprocket, a chain guide provided between the driving sprocket and the driven sprocket and slidably supporting the timing chain, and a guide support member supporting the chain guide, wherein the chain guide comprises a fastening portion fixedly fastened to the cylinder head and a slide support portion provided to extend from the fastening portion toward a side of the cylinder block beyond a boundary between the cylinder block and the cylinder head and supporting the timing chain in an axis-directional view, when viewed from a direction of a rotational axis of the driving sprocket, the slide support portion includes a slide surface on which the timing chain slides and a facing surface which faces the slide surface in the axis-directional view, and the guide support member is configured to slidably contact the facing surface of the slide support portion in the axis-directional view.

According to the present invention, the workability of the maintenance requiring the removal of the cylinder head can be improved even in a state where the engine is installed to the vehicle. Specifically, since the chain guide is not fastened to the cylinder block, the timing chain device of the engine is configured such that the cylinder head can be removed without releasing the fastening of the chain guide to the cylinder head.

Herein, since the guide support member slidably contacts the facing surface of the slide support portion of the chain guide, the timing chain device of the engine is configured such that when the cylinder head is removed, a move of the chain guide to be removed from the cylinder block is not blocked by the guide support member.

Further, the guide support member can guide the move of the chain guide when the cylinder head is attached to the cylinder block. Therefore, the timing chain device of the engine is configured such that the cylinder head to which the chain guide is fastened can be easily installed to the cylinder block even in the state where the engine is installed to the vehicle. Thus, the present timing chain device of the engine can improve the workability of the maintenance requiring the removal of the cylinder head even in the state where the engine is installed to the vehicle.

In an embodiment of the present invention, the timing chain is arranged between the cylinder block and a transmission which is connected to the engine.

According to this embodiment, the timing chain device of the engine is configured such that removing of the transmission and releasing of fastening of the chain guide can be unnecessary even in a case where the timing chain is positioned between the cylinder block and the transmission. Thus, the present timing chain device of the engine can further improve the workability of the maintenance requiring the removal of the cylinder head even in the case where the timing chain is positioned between the cylinder block and the transmission.

In another embodiment of the present invention, the chain guide is configured to slidably support an outer-peripheral-surface side of the timing chain in the axis-directional view, and the guide support member is configured to be fixedly fastened to the cylinder block at a position which overlaps the timing chain in the axis-directional view.

According to this embodiment, the timing chain device of the engine is configured such that the workability of the maintenance requiring the removal of the cylinder head can be further improved and also it can be prevented that the cylinder block has a large size in a cross direction which crosses relative to the axis-directional view.

In another embodiment of the present invention, the guide support member is constituted by a chain cover which is installed to the cylinder block such that the timing chain is interposed between the chain cover and the cylinder block.

According to this embodiment, the timing chain device of the engine is configured such that the workability of the maintenance requiring the removal of the cylinder head can be improved, suppressing an increase of the parts number, compared with a case where the guide support member is made separately from the cylinder block or the chain cover.

In another embodiment of the present invention, the guide support member comprises a fitting portion which fits an end portion of the slide support portion of the chain guide through recess/projection fitting.

According to this embodiment, the timing chain device of the engine is configured such that when the cylinder head to which the chain guide is fastened is installed to the cylinder block, a relative position of the chain guide to the cylinder block can be easily positioned even in a case where visual recognition of an end portion of the chain guide is not performed. Further, the present timing chain device of the engine can prevent the chain guide from falling off into a space between the chain cover and the cylinder block when the chain guide is installed to the cylinder head which has been installed to the cylinder block or when fastening of the chain guide is released. Thus, the present timing chain device of the engine can securely improve the workability of the maintenance requiring the removal of the cylinder head even in the state where the engine is installed to the vehicle.

Other features, aspects, and advantages of the present invention will become apparent from the following description which refers to the accompanying drawings.

### BRIEF DESCRIPTION OF THE DRAWINGS

FIG. 1 is a back view of an engine and a transmission.

FIG. 2 is a left side view of an engine body.

FIG. 3 is an enlarged view of a major part of the engine body shown in FIG. 2.

FIG. 4 is a perspective back view of a chain guide for a timing chain and a support member.

FIG. 5 is a perspective front view of the chain guide for the timing chain and the support member.

FIG. 6 is a perspective back view of the support member.

FIG. 7 is a right side view of a support member according to another embodiment.

### DETAILED DESCRIPTION OF THE INVENTION

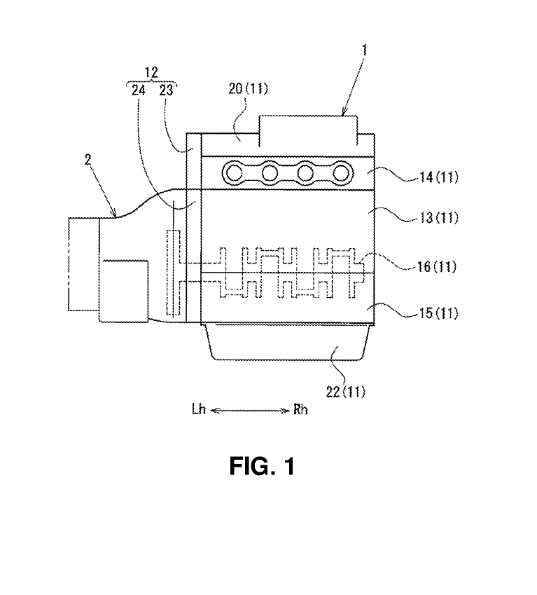

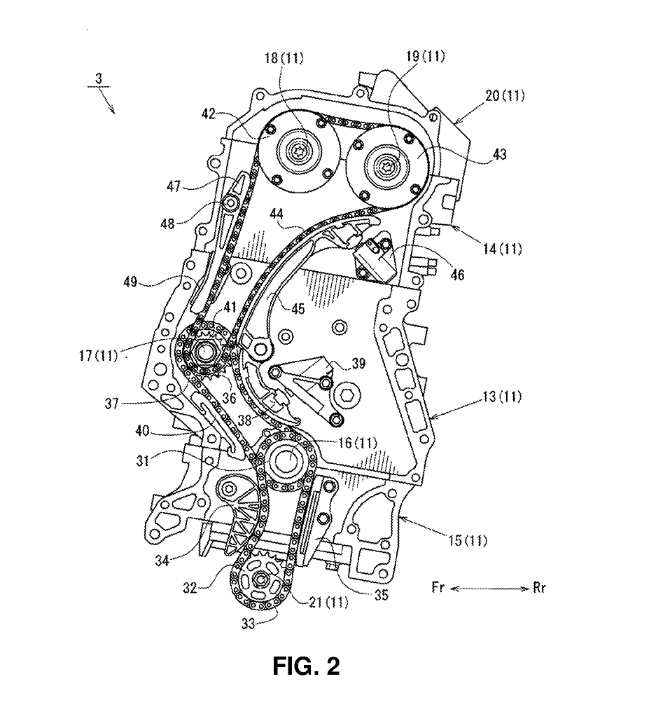

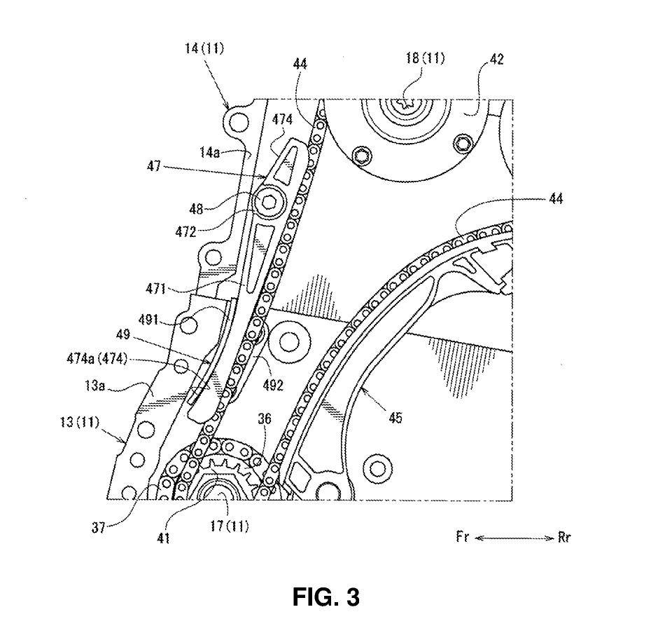

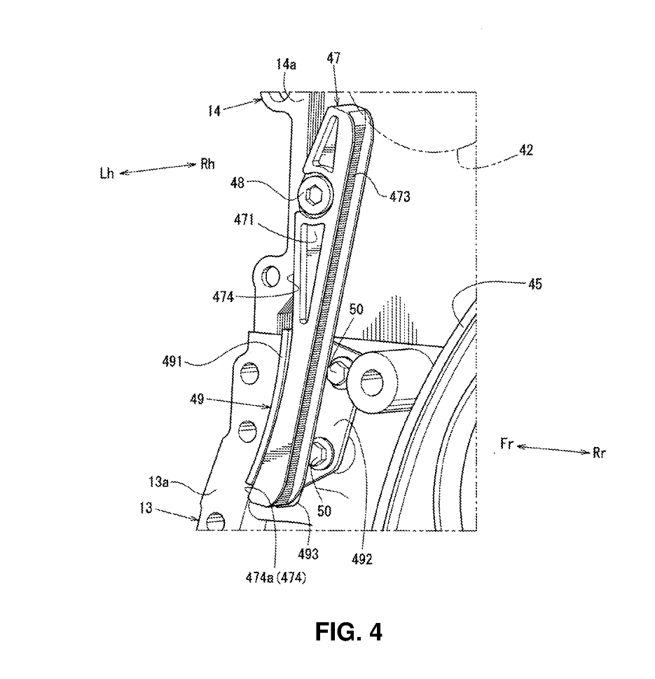

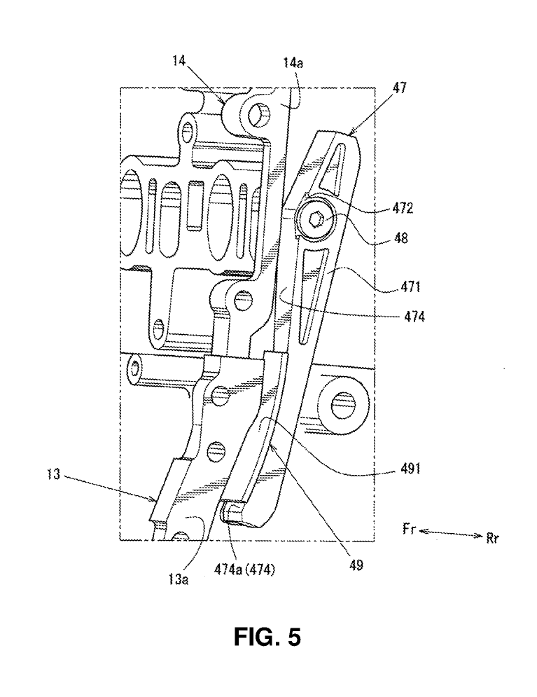

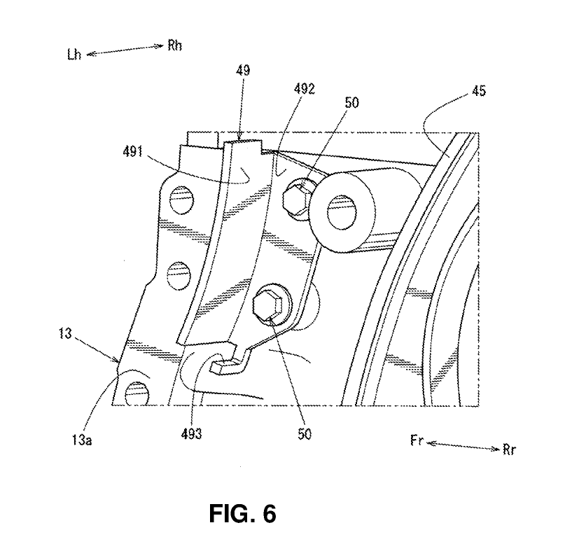

Hereafter, an embodiment of the present invention will be described referring to the drawings. Herein, FIG. 1 shows a back view of an engine 1 and a transmission 2, FIG. 2 shows a left side view of an engine body 11, FIG. 3 shows an enlarged view of a major part of the engine body shown in FIG. 2, FIG. 4 shows a perspective back view of a chain guide 47 for a timing chain and a support member 49, FIG. 5 shows a perspective front view of the chain guide 47 for the timing chain and the support member 49, and FIG. 6 shows a perspective back view of the support member 49.

In the figures, an arrow Fr and an arrow Rr show a longitudinal direction, the arrow Fr showing a forward direction and the arrow Rr showing a rearward direction. An arrow Rh and an arrow Lh show a width direction, the arrow Rh showing a rightward direction and the arrow Lh showing a leftward direction. Additionally, an upper side of FIG. 1 shows an upward side and a lower side of FIG. 1 shows a downward side.

The engine 1 at which a chain device of the present embodiment is arranged is an internal-combustion engine which is operated by fuel, such as gasoline, specific illustration of which is omitted, and this engine is arranged in an engine room which is provided at a front portion of the vehicle. Herein, the engine 1 of the present embodiment is a so-called transverse engine, and the transmission 2 is connected to a left side, in the width direction, of the engine 1, as shown in FIG. 1.

More specifically, the engine 1 comprises, as shown in FIG. 1, an engine body 11 and a chain cover 12 which is installed to a left-side face, in the width direction, of the engine body 11. The engine 1 is provided to slant such that its upper portion is positioned slightly rearward relative to its lower portion in the left side view as shown in FIG. 2.

As sown in FIGS. 1 and 2, the engine body 11 comprises three blocks of a cylinder block 13, a cylinder head 14 which is installed to an upper face of the cylinder block 13, and a lower block 15 which is installed to a lower face of the cylinder block 13.

The cylinder block 13 is the block where plural cylinders, pistons (not illustrated), a crankshaft 16 which extends in the width direction, a fuel pomp (not illustrated) for supplying fuel to combustion chambers, and others are provided. As shown in FIGS. 1 and 2, the cylinder block 13 rotatably supports the crankshaft 16 at a roughly central portion, in a longitudinal direction, of the lower face of the cylinder block 13 in the left side view.

Herein, the crankshaft 16 is arranged such that its axial center is positioned on the lower face of the cylinder block 13, and it rotates counterclockwise in the left side view. Further, the cylinder block 13 rotatably supports a fuel-pump drive shaft 17 to drive a fuel pump (not illustrated) at a position which is located upward and forward relative to the crankshaft 16 as shown in FIG. 2.

The cylinder head 14 is the block where an upper portion (not illustrated) of the combustion chambers, intake valves (not illustrated) to open/close intake ports, exhaust valves (not illustrated) to open/close exhaust valves, an intake camshaft 18 which extends in the width direction and drives opening/closing of the intake valves, an exhaust camshaft 19 which extends in the width direction and drives opening/closing of the exhaust valves, and others are provided. As shown in FIG. 2, the cylinder head 14 rotatably supports the intake camshaft 18 at its upper-front side and also rotatably supports the exhaust camshaft 19 at its upper-rear side.

Herein, the intake camshaft 18 and the exhaust camshaft 19 are arranged such that their axial centers are positioned on the upper face of the cylinder head 14 in the left side view as shown in FIGS. 1 and 2. Further, as shown in FIGS. 1 and 2, a head cover 20 which covers over the intake camshaft 18 and the exhaust camshaft 19 is installed to the upper face of the cylinder head 14.

The lower block 15 is the block where an oil pump (not illustrated) for circulating engine oil as lubricating oil inside the engine 1 and others are provided. As shown in FIG. 2, this lower block 15 rotatably supports an oil-pump drive shaft 21 to drive the oil pump (not illustrated) at a position located below the crankshaft 16 in the left side view. Herein, an oil pan 22 is installed to a lower face of the lower block 15 such that it covers the oil-pump drive shaft 21 as shown in FIG. 1.

As shown in FIG. 1, the chain cover 12 comprises an upper chain cover 23 which covers over a left side face of the cylinder head 14 and a left side face of the head cover 20 and a lower chain cover 24 which covers over a left side face of the cylinder block 13 and a left side face of the lower block 15. Herein, the above-described transmission 2 is connected to the cylinder block 13 and the lower block 15 of the engine body 11 via the lower chain cover 24.

Further, as shown in FIGS. 1 and 2, a chain device 3 which drives the fuel-pump drive shaft 17, the exhaust camshaft 19, the intake camshaft 18, and the oil-pump drive shaft 21 is arranged at a portion which is covered with engine body 11 and the chain cover 12.

More specifically, the chain device 3 of the engine 1 comprises, as shown in FIG. 2, a crank sprocket 31 which is provided at the crankshaft 16, an oil-pump sprocket 32 which is provided at the oil-pump drive shaft 21, an oil-pump chain 33 which is stretched between the crank sprocket 31 and the oil-pump sprocket 32, a tensioner arm 34 for the oil-pump chain 33, a tensioner (not illustrated) for the oil-pump chain, and the chain guide 35 for the oil-pump chain.

Further, the chain device 3 of the engine 1 comprises, as shown in FIG. 2, a large-diameter sprocket 36 which is provided at the fuel-pump drive shaft 17, a fuel-pump chain 37 which is stretched between the crank sprocket 31 and the large-diameter sprocket 36, a tensioner arm 38 for the fuel-pump chain, a tensioner 39 for the fuel-pump chain, and a chain guide 40 for the fuel-pump chain.

In addition, the chain device 3 of the engine 1 comprises, as shown in FIG. 2, a small-diameter sprocket 41 which has a smaller diameter than the large-diameter sprocket 36 and is provided at the fuel-pump drive shaft 17, an intake-cam sprocket 42 which is provided at the intake camshaft 18, an exhaust-cam sprocket 43 which is provided at the intake camshaft 19, a timing chain 44 which is stretched among the small-diameter sprocket 41, the intake-cam sprocket 42, and the exhaust-cam sprocket 43, a tensioner arm 45 for the timing chain, a tensioner 46 for the timing chain, and a chain guide 47 for the timing chain.

The oil-pump chain 33 is, as shown in FIG. 2, stretched between the crank sprocket 31 as a driving sprocket and the oil-pump sprocket 32 as a driven sprocket so as to be rotated counterclockwise by a drive force of the crank sprocket 31 in the left side view.

Therefore, the oil-pump chain 33 is configured such that a portion thereof which runs roughly upward from the oil-pump sprocket 32 toward the crank sprocket 31 becomes a tension side, whereas another portion thereof which runs roughly downward from the crank sprocket 31 toward the oil-pump sprocket 32 becomes a loose side in the left side view as shown in FIG. 2.

The tensioner arm 34 for the oil-pump chain is arranged in front of the loose side of the oil-pump chain 33 as shown in FIG. 2. More specifically, the tensioner arm 34 for the oil-pump chain is of a magatama shape having a rearward-protruding arc portion so that the loose side of the oil-pump chain 33 slidably contacts it.

Further, a lower portion of the tensioner arm 34 for the oil-pump chain is a free end in the left side view, and an upper portion of the tensioner arm 34 is rotatably supported at the lower block 15 which is positioned in front of the loose side of the oil-pump chain 33.

The tensioner for the oil-pump chain, specific illustration of which is omitted, is arranged such that the lower portion of the tensioner arm 34 for the oil-pump chain can be pushed rearward from a forward side, that is, toward an inner peripheral surface of the oil-pump chain 33 from an outer peripheral surface of the oil-pump chain 33. Thereby, the tensioner arm 34 for the oil-pump chain applies a tensional force to the loose side of the oil-pump chain 33.

The chain guide 35 for the oil-pump chain is, as shown in FIG. 2, arranged in back of the tension side of the oil-pump chain 33 and guides such that the tension side of the oil-pump chain 33 can run.

More specifically, the chain guide 35 for the oil-pump chain has a vertically-long shape, in the left side view, such that the outer peripheral surface of the tension side of the oil-pump chain 33 can slide thereon. Further, the chain guide 35 for the oil-pump chain is fixedly fastened to the lower block 15 which is positioned in back of the tension side of the oil-pump chain 33, in the left side view, at its upper portion and its lower portion.

As shown in FIG. 2, the fuel-pump chain 37 is stretched between the crank sprocket 31 as the driving sprocket and the large-diameter sprocket 36 as the driven sprocket such that it can be rotated counterclockwise, in the left side view, by the drive force of the crank sprocket 31.

Accordingly, as shown in FIG. 2, the fuel-pump chain 37 is configured, in the left side view, such that a portion thereof which runs roughly rearward and downward from the large-diameter sprocket 36 toward the crank sprocket 31 becomes a tension side, whereas another portion thereof which runs roughly forward and upward from the crank sprocket 31 toward the large-diameter sprocket 36 becomes a loose side.

The tension arm 38 for the fuel-pump chain is, as shown in FIG. 2, arranged above and rearward of the loose side of the fuel-pump chain 37 and guides such that the outer peripheral surface of the loose side of the fuel-pump chain 37 can slide thereon.

More specifically, as shown in FG 2, the tension arm 38 for the fuel-pump chain has a length which extends from the vicinity of the crank sprocket 31 to the vicinity of the large-diameter sprocket 36, and is configured in a roughly arc shape in the side view such that a surface thereof which faces the loose side of the fuel-pump chain 37 curves, protruding slightly forward and downward.

A lower portion of the tensioner arm 38 for the fuel-pump chain is a free end, whereas an upper portion of the tensioner arm 38 is rotatably supported at the cylinder block 13 which is positioned near the large-diameter sprocket 36 and in back of the loose side of the fuel-pump chain 37. The tensioner 39 for the fuel-pump chain is, as shown in FIG. 2, fixedly fastened to the cylinder block 13 which is positioned above and in back of the tension arm 38 for the fuel-pump chain in the left side view.

More specifically, the tensioner 39 for the fuel-pump chain is arranged such that a lower portion of the tensioner arm 38 for the fuel-pump chain can be pushed forward and downward, that is, toward an inner peripheral surface of the fuel-pump chain 37 from an outer peripheral surface of the fuel-pump chain 37. Thereby, the tensioner arm 38 for the fuel-pump chain applies a tensional force to the loose side of the fuel-pump chain 37.

The chain guide 40 for the oil-pump chain is, as shown in FIG. 2, arranged in front of the tension side of the fuel-pump chain 37 and guides such that the tension side of the fuel-pump chain 37 can run.

More specifically, as shown in FG 2, the tension guide 40 for the fuel-pump chain has a length which extends from the vicinity of the crank sprocket 31 to the vicinity of the large-diameter sprocket 36 in the left side view, and is configured in a shape such that an outer peripheral surface of the tension side of the chain guide 40 for the fuel-pump chain can slide thereon. The tension guide 40 for the fuel-pump chain is fixed to the cylinder block 13 which is positioned in front of the tension side of the fuel-pump chain 37 in the left side view.

Further, the timing chain 44 is stretched among the small-diameter sprocket 41 as the driving sprocket and the exhaust-cam sprocket 43 and the intake-cam sprocket 42 as the driven sprockets such that it can be rotated counterclockwise, in the left side view, by the drive force of the small-diameter sprocket 41.

Accordingly, as shown in FIG. 2, the timing chain 44 is configured, in the left side view, such that a portion thereof which runs roughly downward from the intake-cam sprocket 42 toward the small-diameter sprocket 41 becomes a tension side, whereas another portion thereof which runs roughly upward from the small-diameter sprocket 41 toward the exhaust-cam sprocket 436 becomes a loose side.

The tension arm 45 for the timing chain is, as shown in FIG. 2, arranged in back of the loose side of the timing chain 44 and guides such that an outer peripheral surface of the loose side of the timing chain 44 can slide thereon.

More specifically, as shown in FG 2, the tension arm 45 for the timing chain has a length which extends from the vicinity of the small-diameter sprocket 41 to the vicinity of the exhaust-cam sprocket 43, that is, a length which extend over the cylinder block 13 and the cylinder head 14, and is configured in a roughly arc shape in the side view such that a surface thereof which faces the loose side of the timing chain 44 curves, protruding slightly forward and upward.

An upper portion of the tensioner arm 45 for the timing chain is a free end, whereas a lower portion of the tensioner arm 45 is rotatably supported at the cylinder block 13 together with the upper portion of the tension arm 38 for the fuel-pump chain. The tensioner 46 for the timing chain is, as shown in FIG. 2, fixedly fastened to the lower portion of the cylinder head 14 which is positioned in back of the tension arm 45 for the timing chain in the left side view.

More specifically, the tensioner 46 for the timing chain is arranged such that an upper portion of the tensioner arm 458 for the timing chain can be pushed forward and upward, that is, toward an inner peripheral surface of the timing chain 44. Thereby, the tensioner arm 45 for the timing chain applies a tensional force to the loose side of the timing chain 44.

The chain guide 47 for the timing chain is, as shown in FIG. 2, arranged in front of the tension side of the timing chain 44, in the left side view, and guides such that the tension side of the timing chain 44 can run.

More specifically, as shown in FG 2, the tension guide 47 for the timing chain has a vertical length which extends from the vicinity of the intake-cam sprocket 42 to the vicinity of the small-diameter sprocket 41 in the left side view, and is configured in a shape such that an outer peripheral surface of the tension side of the timing chain 44 can slide thereon.

The chain guide 47 for the timing chain is, as shown in FIG. 2, fixedly fastened to the cylinder head 14 which is positioned in front of the tension side of the timing chain 44, in the left side view, at an upper portion thereof.

Subsequently, the chain guide 47 for the timing chain according to the present embodiment will be described specifically referring to FIGS. 3 through 6. As shown in FIG. 3, the chain guide 47 for the timing chain is constituted integrally by a slide support portion 471 which supports a slide of the tension side of the timing chain 44 and a fastening portion 472 which is fixedly fastened to the cylinder block 13 by a bolt with hexagon socket 48 at a position slightly below an upper end of the slide support portion 471.

The chain guide 47 for the timing chain is, as shown in FIGS. 4 and 5, configured to have a width-directional length such that it protrudes outward, in the width direction, beyond a flange flat face 14a of the cylinder head 14 which an outer-peripheral edge portion of the upper chain cover 12 contacts and a flange flat face 13a of the cylinder block 13 which an outer-peripheral edge portion of the lower chain cover 12 contacts.

As shown in FIG. 3, the slide support portion 471 is configured in the left side view such that its upper portion which is positioned upward from the fastening portion 472 tapers off to a point and its lower portion which is positioned downward from the fastening portion 472 tapers off to a point. Specifically, a rear surface 473 of the slide support portion 471 which is a slide surface where the timing chain 44 slides is configured to be substantially a flat surface which is roughly parallel to the outer peripheral surface of the tension side of the timing chain 44 as shown in FIG. 3.

Meanwhile, as shown in FIGS. 3 and 4, a front surface 474 of the slide support portion 471 which faces the rear surface 473 is configured such that its upper portion which is positioned upward from the fastening portion 472 slants such that its upper end is located rearward from its lower end, whereas its lower portion which is positioned downward from the fastening portion 472 slants such that its lower end is located rearward from its upper end, in the left side view.

Further, the front surface 474 of the slide support portion 471 is configured in a curved shape such that a front-surface lower portion 474a which is positioned downward from the upper face of the cylinder block 13 slightly protrudes rearward in the left side view as shown in FIGS. 3 and 4. That is, the slide support portion 471 is configured in the left side view such that the rear surface 473 is substantially linear, whereas the front surface 474 is bent at the fastening portion 472.

In addition, a recess portion (not illustrated) which is configured to be recessed roughly upward is formed at a lower end of the slide support portion 471. A projection 493 of the support member 49, which will be described specifically, is provided to fit this recess portion through recess/projection fitting in a separation direction of the cylinder head 14 separated from the cylinder block 13, i.e., in a roughly vertical direction.

In the above-described chain guide 47 for the timing chain, a tensional force of the tension side of the timing chain 44 acts thereon toward a forward side from a rearward side when the timing chain 44 runs. Accordingly, as shown in FIGS. 3 and 4, the chain device 3 prevents the chain guide 47 for the timing chain from swinging clockwise, in the left side view, around a rotational center at the bolt with the hexagon socket 48 by means of the support member 49 fixedly fastened to the cylinder block 13. This support member 49 is arranged between the chain guide 47 for the timing chain and the flange flat face 13a of the cylinder block 13 in the left side view as shown in FIG. 3.

More specifically, as shown in FIGS. 3 through 6, the support member 49 is arranged between the chain guide 47 for the timing chain and the flange flat face 13a of the cylinder block 13 and also formed integrally by the a contact portion 491 which slidably contacts the front-surface lower portion 474a of the chain guide 47 for the timing chain, a roughly flat-plate shaped base portion 492 which extends rearward from a right end portion of the contact portion 491, and the projection 493 which extends from a lower end of the base portion 492.

The contact portion 491 is, as shown in FIGS. 3 through 6, has a width-directional length such that it protrudes leftward, in the width direction, beyond the flange flat face 13a of the cylinder block 13 and the chain guide 47 for the timing chain.

Further, the contact portion 491 is configured such that a flat plate which has a thickness in the longitudinal direction is slightly curved so as to match the front-surface lower portion 474a of the slide support portion 471 of the chain guide 47 for the timing chain. Herein, the contact portion 491 has a smaller curvature radius than that of the front-surface lower portion 474a of the chain guide 47 for the timing chain.

As shown in FIGS. 3 and 6, the base portion 492 has a length, in the longitudinal direction, which is slightly longer than a combined length of the chain guide 47 for the timing chain and the timing chain 44 in the left side view, and is configured in a flat-plate shape which is of a roughly vertically-long rectangular shape in the left side view.

The base portion 492 is, as shown in FIGS. 3 and 6, fixedly fastened to the cylinder block 13 by means of two fastening bolts 50 which are arranged at a positon which overlaps the timing chain 44 in the left side view.

The projection 493 is configured, as shown in FIG. 6, such that it extends roughly downward from a lower end of the base portion 492 and is bent leftward in the width direction. This projection 493 has a size such that it fits the recess portion (not illustrated) provided at the lower end of the chain guide 47 for the timing chain through recess/projection fitting in the roughly vertical direction.

The above-described chain device 3 of the engine 1 can improve the workability of the maintenance requiring the removal of the cylinder head 14 even in a state where the engine 1 is installed to the vehicle. Specifically, since the chain guide 47 for the timing chain is not fastened to the cylinder block 13, the chain device 3 of the engine 1 is configured such that the cylinder head 14 can be removed without releasing the fastening of the chain guide 47 for the timing chain to the cylinder head 14.

Herein, since the support member 49 slidably contacts the front-surface lower portion 474a of the slide support portion 471 of the chain guide 47 for the timing chain, the chain device 3 of the engine 1 is configured such that when the cylinder head 14 is removed, a move of the chain guide 47 for the timing chain to be removed from the cylinder block 3 is not blocked by the support member 49.

Further, the support member 49 can guide the move of the chain guide 47 for the timing chain when the cylinder head 14 is attached to the cylinder block 13. Therefore, the chain device 3 of the engine 1 is configured such that the cylinder head 14 to which the chain guide 47 for the timing chain is fastened can be easily installed to the cylinder block 13 even in the state where the engine 1 is installed to the vehicle.

Thus, the chain device 3 of the engine 1 can improve the workability of the maintenance requiring the removal of the cylinder head 14 even in the state where the engine 1 is installed to the vehicle.

Further, since the timing chain 44 is arranged between the cylinder block 13 and the transmission 2, the chain device 3 of the engine 1 is configured such that removing of the transmission 2 and releasing of fastening of the chain guide 47 for the timing chain can be unnecessary even in a case where the timing chain 44 is positioned between the cylinder block 13 and the transmission 2.

Thus, the chain device 3 of the engine 1 can further improve the workability of the maintenance requiring the removal of the cylinder head 14 even in the case where the timing chain 44 is positioned between the cylinder block 13 and the transmission 2.

Moreover, since the support member 49 is fixedly fastened to the cylinder block 13 at a position which overlaps the timing chain 44 in the left side view, the chain device 3 of the engine 1 is configured such that the workability of the maintenance requiring the removal of the cylinder head 14 can be further improved and also it can be prevented that the cylinder block 13 has a large size outward in the width direction.

Also, since the support member 49 comprises the projection 493 which fits the recess portion of the slide support portion 471 of the chain guide 47 for the timing chain through recess/projection fitting, the chain device 3 of the engine 1 is configured such that when the cylinder head 14 to which the chain guide 47 for the timing chain is fastened is installed to the cylinder block 13, a relative position of the chain guide 47 for the timing chain to the cylinder block 13 can be easily positioned even in a case where visual recognition of the lower portion of the chain guide 47 for the timing chain is not performed.

Further, the chain device 3 of the engine 1 can prevent the chain guide 47 for the timing chain from falling off into a space between the lower chain cover 24 and the cylinder block 13 when the chain guide 47 for the timing chain is installed to the cylinder head 14 which has been installed to the cylinder block 13 or when fastening of the chain guide 47 for the timing chain is released.

Thus, the chain device 3 of the engine 1 can securely improve the workability of the maintenance requiring the removal of the cylinder head 14 even in the state where the engine 1 is installed to the vehicle.

Moreover, since the support member 49 contacts the front-surface lower portion 473a of the chain guide 47 for the timing chain, the chain device 3 of the engine 1 is configured such that it can be prevented that the chain guide 47 for the timing chain is rotated clockwise, in the left side view, together with the bolt with the hexagon socket 48, when the bolt with the hexagon socket 48 is fastened clockwise in the left side view.

Thus, even in a case where the chain guide 47 for the timing chain is fastened to the cylinder head 14 in the state where the cylinder block 13, the cylinder head 14, and the lower chain cover 24 are assembled, the chain device 3 of the engine 1 is configured such that it can be prevented that the assembling performance of the chain guide 47 for the timing chain is deteriorated.

In correspondence between the present invention and the above-described embodiment, the drive sprocket of the invention corresponds to the small-diameter sprocket 41 of the embodiment. Likewise, the driven sprocket corresponds to the intake-cam sprocket 42 and the exhaust-cam sprocket 43, the timing chain device corresponds to the chain device 3, the chain guide corresponds to the chain guide 47 for the timing chain, the guide support member corresponds to the support member 49, the axis-directional view corresponds to the left side view, the slide surface of the slide support portion corresponds to the rear surface 473 of the slide support portion 471, the facing surface of the slide support portion corresponds to the front-surface lower portion 474a of the slide support portion 471, the chain cover corresponds to the lower chain cover 24, the end portion of the slide support portion corresponds to the recess portion of the slide support portion 471, and the fitting portion of the guide support member corresponds to the projection 493 of the support member 49. However, the present invention is not limited to the above-described embodiment, but any other embodiments can be applied.

For example, while the small-diameter sprocket 41 is the driving sprocket in the above-described embodiment, the crank sprocket 31 may be the driving sprocket. In this case, the timing chain is stretched among the intake-cam sprocket 42, the exhaust-cam sprocket 43, and the crank sprocket 31.

Further, while the support member 49 which prevents the chain guide 47 for the timing chain from swinging is formed separately from the cylinder block 13, the support member to prevent swinging of the chain guide 47 for the timing chain may be constituted by the lower chain cover 24.

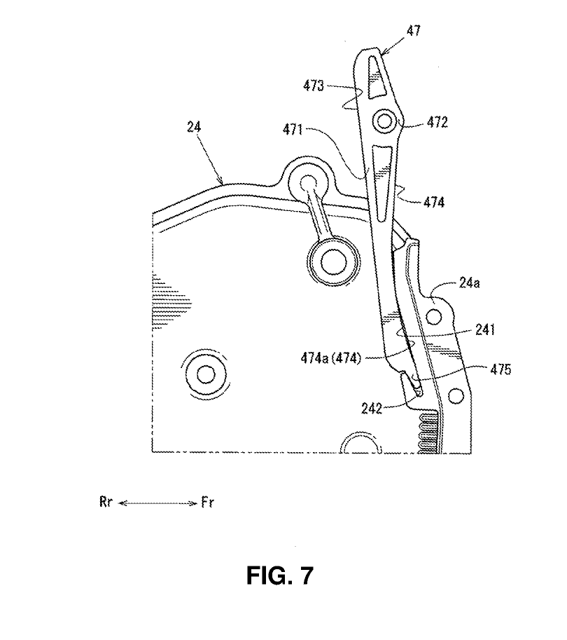

Specifically, in a portion of the lower chain cover 24 which faces the chain guide 47 for the timing chain as shown in a right side view of FIG. 7 which illustrates the support member 49 according to another embodiment, an inside face 241 which extends leftward from a rear end edge of a contact face 24a which the flange flat face 13a of the cylinder block 13 contacts may be the contact portion which the front-surface lower portion 474a of the chain guide 47 for the timing chain slidably contacts.

Herein, the inside face 241 of the lower chain cover 24 is configured in a curved shape to have a slightly-smaller curvature diameter than the front-surface lower portion 474a of the chain guide 47 for the timing chain. Thereby, the chain device 3 of the engine 1 is configured such that the workability of the maintenance requiring the removal of the cylinder head 14 can be improved, suppressing an increase of the parts number, compared to a case where the support member is formed separately from the cylinder block 13 and the lower chain cover 24.

Further, while the projection 493 which is provided at the support member 49 fits the recess portion which is provided at the chain guide 47 for the timing chain through the recess/projection fitting, a projection provided at the chain guide 47 for the timing chain is configured to fit a recess portion provided at the support member in a separation direction of the cylinder head 14 separated from the cylinder block 13, i.e., in the roughly vertical direction.

For example, as shown in FIG. 7, a projection 475 which protrudes roughly downward is formed at the lower end of the chain guide 47 for the timing chain, and a recess portion 242 which is continuous from the inside face 241 is formed at the lower chain cover 24 which supports the chain guide 47 for the timing chain.

Further, the projection 475 of the chain guide 47 for the timing chain is configured to fit the recess portion 242 of the lower chain cover 24 in the separation direction of the cylinder head 14 separated from the cylinder block 13, i.e., in the roughly vertical direction.

Thereby, the chain device 3 of the engine 1 is configured such that the relative position of the chain guide 47 for the timing chain to the cylinder block 13 can be easily positioned when the cylinder head 14 to which the chain guide 47 for the timing chain is fastened is installed to the cylinder block 13 even in a case where visual recognition of the lower portion of the chain guide 47 for the timing chain is not performed.

Moreover, for example, the chain device 3 of the engine 1 can prevent the chain guide 47 for the timing chain from falling off into the space between the lower chain cover 24 and the cylinder block 13 when the chain guide 47 for the timing chain is installed to the cylinder head 14 which has been installed to the cylinder block 13 or when fastening of the chain guide 47 for the timing chain is released.

Thus, the chain device 3 of the engine 1 can securely improve the workability of the maintenance requiring the removal of the cylinder head 14 even in the state where the engine 1 is installed to the vehicle.

What is claimed is:

1. A timing chain device of an engine, comprising:
a driving sprocket rotatably supported at a cylinder block of the engine;
a driven sprocket rotatably supported at a cylinder head installed to the cylinder block;
a timing chain stretched between the driving sprocket and the driven sprocket;
a chain guide provided between the driving sprocket and the driven sprocket and slidably supporting the timing chain; and
a guide support member supporting the chain guide;
wherein said chain guide comprises a fastening portion fixedly fastened to the cylinder head and a slide support portion provided to extend from said fastening portion toward a side of the cylinder block beyond a boundary between the cylinder block and the cylinder head and supporting said timing chain in an axis-directional view, when viewed from a direction of a rotational axis of the driving sprocket,
said slide support portion includes a slide surface on which said timing chain slides and a facing surface which faces said slide surface in said axis-directional view, and
said guide support member is configured to slidably contact said facing surface of the slide support portion in said axis-directional view.

2. The timing chain device of the engine of claim 1, wherein said timing chain is arranged between the cylinder block and a transmission which is connected to the engine.

3. The timing chain device of the engine of claim 1, wherein said chain guide is configured to slidably support an outer-peripheral-surface side of said timing chain in said axis-directional view, and said guide support member is configured to be fixedly fastened to the cylinder block at a position which overlaps the timing chain in said axis-directional view.

4. The timing chain device of the engine of claim 2, wherein said chain guide is configured to slidably support an outer-peripheral-surface side of said timing chain in said axis-directional view, and said guide support member is configured to be fixedly fastened to the cylinder block at a position which overlaps the timing chain in said axis-directional view.

5. The timing chain device of the engine of claim 1, wherein said guide support member is constituted by a chain cover which is installed to the cylinder block such that said timing chain is interposed between the chain cover and the cylinder block.

6. The timing chain device of the engine of claim 2, wherein said guide support member is constituted by a chain cover which is installed to the cylinder block such that said timing chain is interposed between the chain cover and the cylinder block.

7. The timing chain device of the engine of claim 1, wherein said guide support member comprises a fitting portion which fits an end portion of the slide support portion of said chain guide through recess/projection fitting.

8. The timing chain device of the engine of claim 2, wherein said guide support member comprises a fitting portion which fits an end portion of the slide support portion of said chain guide through recess/projection fitting.

9. The timing chain device of the engine of claim 3, wherein said guide support member comprises a fitting portion which fits an end portion of the slide support portion of said chain guide through recess/projection fitting.

10. The timing chain device of the engine of claim 4, wherein said guide support member comprises a fitting portion which fits an end portion of the slide support portion of said chain guide through recess/projection fitting.

11. The timing chain device of the engine of claim 5, wherein said guide support member comprises a fitting portion which fits an end portion of the slide support portion of said chain guide through recess/projection fitting.

12. The timing chain device of the engine of claim 6, wherein said guide support member comprises a fitting portion which fits an end portion of the slide support portion of said chain guide through recess/projection fitting.
